(19) United States
(12) Patent Application Publication
(10) Pub. No.: US 2014/0124996 A1
(43) Pub. Date: May 8, 2014

(54) HANGING MODULE

(71) Applicants: HON HAI PRECISION INDUSTRY CO., LTD., New Taipei (CN); FU DING ELECTRONICAL TECHNOLOGY (JIASHAN) CO., LTD, Zhejiang (CN)

(72) Inventor: FA-RONG JIANG, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 14/066,694

(22) Filed: Oct. 30, 2013

(30) Foreign Application Priority Data
Nov. 6, 2012 (CN) 2012205781598

(51) Int. Cl. B05C 13/00

(52) U.S. Cl. CPC B05C 13/00
USPC 269/46

(57) ABSTRACT

A hanging module includes a fixing rod, a support arm, a plurality of fasteners, and a hanging assembly positioned on the support arm by the plurality of fasteners. The support arm is fixed to the fixing rod. The support arm defines a groove. The hanging assembly includes a locking member and a hanging member fixed to the locking member. The hanging member is received in the groove, and fixed to the locking member by the plurality of fasteners.

### BACKGROUND

1. Technical Field

The present disclosure relates to hanging modules, particularly to a hanging module configured for supporting workpieces, such as housings of portable electronic devices.

2. Description of Related Art

A plurality of workpieces may be hung by fasteners on a hanging module for an anodizing process. However, when in an anodizing process, the hanging tool may be immersed in the anodizing solution (such as sulphuric acid solution), which results in the fasteners being corroded by the anodizing solution. When the fasteners corrode, the elastic sheets may be loosened or dropped, or failing to conduct electricity, which thereby affects the anodizing production adversely. In order to prevent the fasteners from loosening, more fasteners are used in the hanging module, which results in a higher labor cost and lower efficiency.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a hanging module.

FIG. 2 is a partial exploded, isometric view of the hanging module shown in FIG. 1.

FIG. 3 is an enlarged view of a circled portion III shown in FIG. 1.

### DETAILED DESCRIPTION

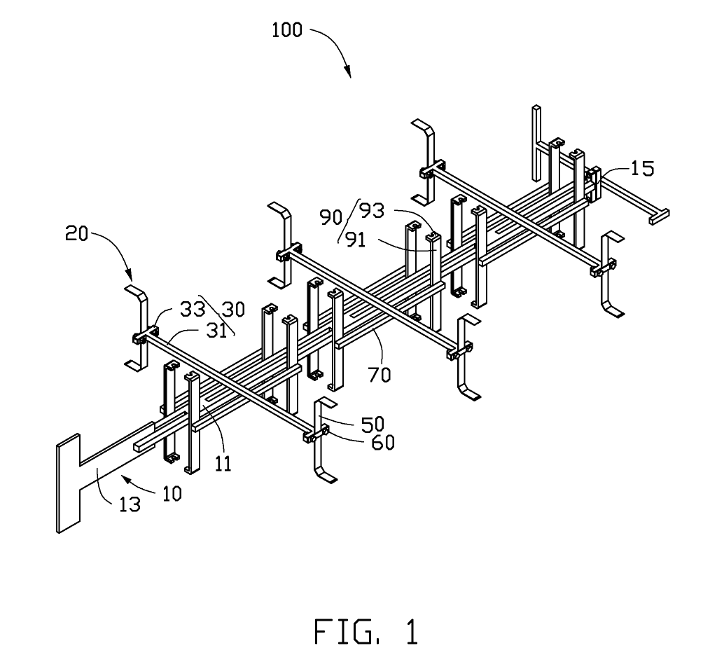

FIG. 1 shows one embodiment of a hanging module 100, for hanging workpieces (not shown). The hanging module 100 includes a fixing rod 10, and at least one latching unit 20 fixed on the fixing rod 10. Each of the at least one latching unit 20 includes a support arm 30, two hanging assemblies 50, a plurality of fasteners 60, two positioning members 70, and four holding members 90. The support arm 30 is mounted on the fixing rod 10. The two hanging assemblies 50 are fixed at opposite ends of the support arm 30 by the plurality of fasteners 60. The positioning members 70 are positioned on the support arm 30, and are arranged apart. The holding members 90 are each hung at opposite ends of the positioning members 70, respectively. Both of the positioning members 70 and the holding members 90 are used for holding workpieces. The hanging module 100 can be used in a cleaning process, an electroplating process, or an anodizing process, for example. In the illustrated embodiment, the hanging module 100 is used in an anodizing process. A number of the latching units 20 is three, and the latching units 20 are spacedly positioned on the fixing rod 10.

The fixing rod 10 includes a rod body 11, a first sliding portion 13, and a second sliding portion 15. The first sliding portion 13 and the second sliding portion 15 are positioned at opposite ends of the rod body 11. The rod body 11 is substantially a rod, and is configured to position the support arms 30 and the positioning members 70, and support the workpieces hung on the hanging module 100. Thus, the rod body 11 is made of materials of high strength. The first sliding portion 13 and the second sliding portion 15 are configured substantially perpendicular to the rod body 11, and are configured to slidably engaged with other mechanisms when in use, thus moving the fixing rod 10 or immersing the workpieces into anodizing solutions.

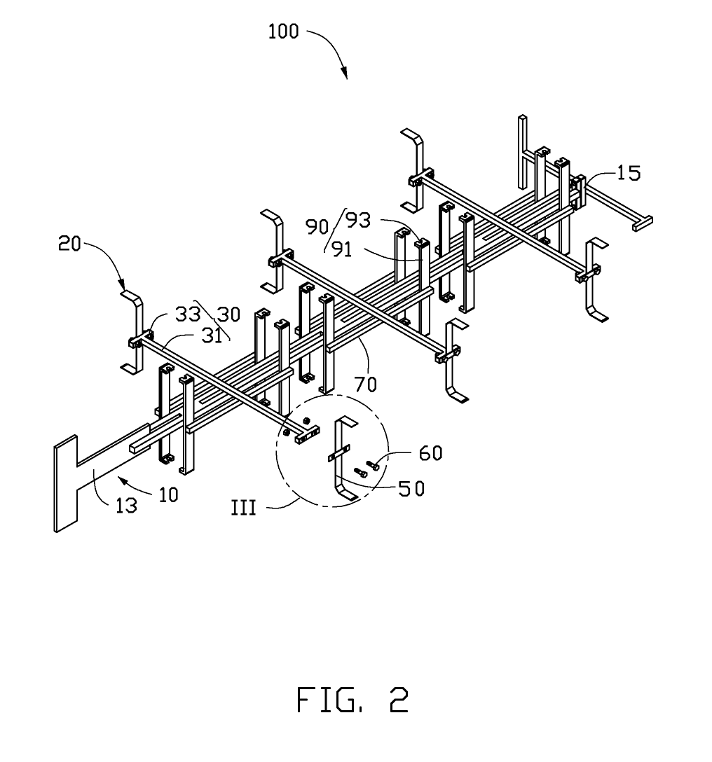

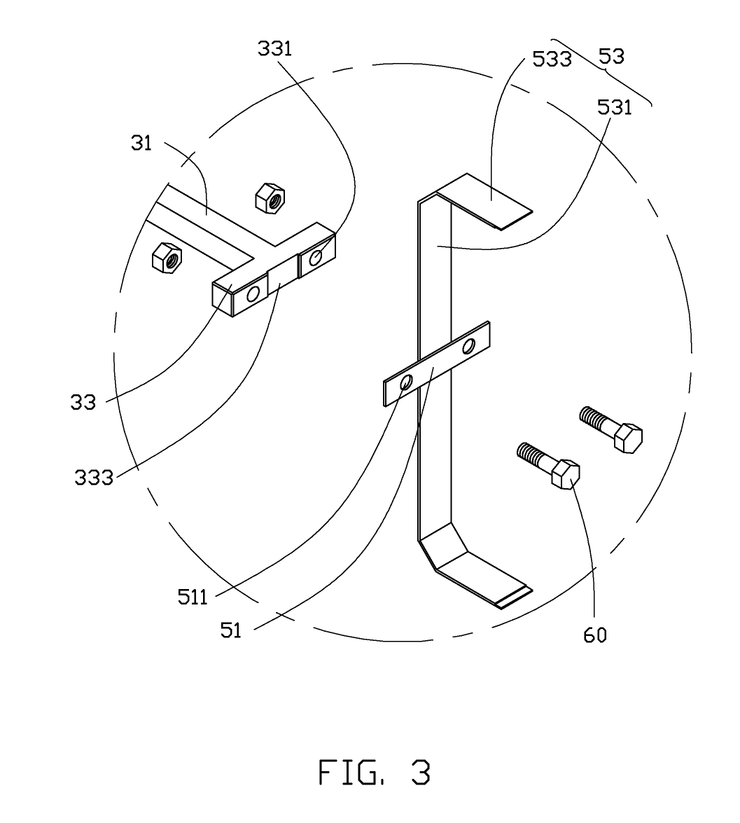

FIGS. 2 and 3 show the support arm 30. The support arm 30 is substantially perpendicularly positioned on the rod body 11. The support arm 30 includes a main body 31 and a pair of mounting portions 33 respectively extending from opposite ends of the main body 31. The main body 31 is substantially a rod; and a substantially middle portion of the main body 31 is connected to the rod body 11, and is disposed to be located on the rod body 11. The mounting portions 33 are respectively perpendicularly extended from the opposite ends of the main body 31, and are substantially parallel to the rod body 11. A substantially middle portion of each mounting portion 33 is connected to the main body 31. Each mounting portion 33 defines two mounting holes 331 adjacent to opposite ends of the mounting portion 33, respectively, and defines a groove 333 at a surface thereof away from the main body 31. The groove 333 is substantially rectangular, and is positioned between the mounting holes 331, for mounting the corresponding hanging assembly 50.

In the illustrated embodiment, the hanging assemblies 50 are respectively mounted at opposite ends of the support arm 30. Each hanging assembly 50 includes a locking member 51 and a hanging member 53 mounted on the locking member 51. The locking member 51 is substantially a rectangular plate, and defines two through holes 511 adjacent to opposite ends of the locking member 51, respectively. The through holes 511 correspond to the mounting holes 331, and a distance between the through holes 511 equals to a distance between the mounting holes 331. The hanging member 53 includes a position portion 531 and a pair of extension portion 533 positioned at opposite ends of the position portion 531. A substantially middle portion of the position portion 531 is fixed to a substantially middle portion of the locking member 51, and the position portion 531 is substantially perpendicular to the locking member 51. The extension portions 533 are respectively extending from opposite ends of the position portion 531, so that the locking member 51 is positioned between the extension portions 533.

The fasteners 60 are inserted into the corresponding through holes 511 and the corresponding mounting holes 331, respectively, to lock the locking member 51 to the mounting portion 33. The position portion 531 is vertically inserted through the groove 333, and is fixed to the mounting portion 33. The extension portions 533 are horizontally positioned; a bottom one extension portion 533 of each pair of extension portions 533 is configured to hang workpieces. In the illustrated embodiment, the locking member 51 and the hanging member 53 are integrated together. In other embodiments, the locking member 51 may be welded with the hanging member 53.

In the illustrated embodiment, the positioning member 70 is a rod; and a substantially middle portion of the positioning member 70 is positioned on the main body 31. The two positioning members 70 are positioned at opposite sides of the rod body 11, and are parallel to each other. The holding members 90 of each latching unit 20 are positioned at opposite ends of the positioning members 70, respectively. Each holding member 90 includes a base portion 91, and a pair of hook portions 93 substantially perpendicularly extending from the base portion 91. A middle portion of the base portion 91 is connected to the corresponding end of the positioning member 70 and is perpendicular to the corresponding position member 70. The hook portions 93 are extended towards the rod body 11. The hook portion 93 located at the bottom is configured to hang workpieces.

In use, workpieces are hung on the extension portions 533 and the hook portions 93, and then the workpieces are put into the anodizing solution. The first sliding portion 13 and the second sliding portion 15 move along a predetermined direction, and the workpieces are moved accordingly and are immersed into different solutions.

Because each hanging assembly 50 is positioned in the corresponding groove 333 and fastened by the fasteners 60, and a contacting surface of the groove 333 and the hanging member 53 is relatively large, an corrosion speed of a portion of the hanging member 53 received in the groove 333 is relatively slow. Thus, the hanging member 53 is capable of steadily mounting on the support arm 30, and is not easily loosened. The fasteners 60 do not need to be replaced very often.

In an alternative embodiment, the positioning member 70 and the holding member 90 may be omitted, and the workpieces are only hung on the hanging assemblies 50. Each hanging member 53 includes one extension portion 533. Each holding member 90 can include just one hook portion 93.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A hanging module, comprising:
a fixing rod;
a support arm fixed to the fixing rod, the support arm defining a groove;
a plurality of fasteners; and
a hanging assembly positioned and fixed on the support arm by the plurality of fasteners, the hanging assembly comprising a locking member and a hanging member fixed to the locking member, the hanging member received in the groove of the support arm, and fixed to the locking member by the plurality of fasteners.

2. The hanging module of claim 1, wherein the hanging member comprises a position portion and at least one extension portion extending from the position portion, the position portion is mounted in the groove of the support arm, and is fixed to the locking member.

3. The hanging module of claim 2, wherein a number of the at least one extension portion is two, and the two extension portions substantially perpendicularly extend from opposite ends of the position portion away from the fixing rod.

4. The hanging module of claim 1, wherein the fixing rod comprises a rod body, a first sliding portion, and a second sliding portion, the first sliding portion and the second sliding portion are positioned at opposite ends of the rod body, a substantially middle portion of the support arm is substantially perpendicularly fixed to the rod body.

5. The hanging module of claim 1, wherein the support arm comprises a main body and at least one mounting portion extending from the main body, the groove is defined on the at least one mounting portion, the plurality of fasteners fix the locking member to the mounting portion.

6. The hanging module of claim 5, wherein the at least one mounting portion is parallel to the rod body, and is perpendicular to the main body.

7. The hanging module of claim 5, wherein the mounting portion defines at least one mounting hole, the locking member defines a through hole corresponding to the mounting hole, one of the plurality of fasteners is inserted into the mounting hole and the through hole, and locks the mounting portion and the locking member.

8. The hanging module of claim 4 further comprising at least one positioning member and at least one holding member, wherein the at least one positioning member is fixed to the support arm, and parallel to the fixing rod, the at least one holding member is mounted on the at least one positioning member.

9. The hanging module of claim 8, wherein the holding member comprises a base portion, and at least one hook portion extending from the base portion, the base portion is substantially perpendicularly mounted to the positioning member.

10. The hanging module of claim 9, wherein a number of the at least one hook portion is two, and the two hook portions are substantially perpendicularly extending from opposite ends of the base portion.

11. A hanging module, comprising:
a fixing rod; and
at least one latching unit fixed on the fixing rod, the at least one latching unit comprising:
a support arm fixed to the fixing rod, the support arm defining two grooves,
a plurality of fasteners, and
two hanging assemblies positioned on opposite ends of the support arm by the plurality of fasteners, each of the hanging assemblies comprising a locking member and a hanging member fixed to the locking member, the hanging member of each of the hanging assemblies is received and positioned in the corresponding groove, and fixed to the locking member by the plurality of fasteners.

12. The hanging module of claim 11, wherein the hanging member comprises a position portion and a pair of extension portions substantially perpendicularly extending from the position portion, the position portion is mounted in the groove of the support arm, and is fixed to the locking member.

13. The hanging module of claim 12, wherein the pair of extension portions extend from opposite ends of the position portion away from the fixing rod.

14. The hanging module of claim 11, wherein the fixing rod comprises a rod body, a first sliding portion and a second sliding portion, the first sliding portion and the second sliding portion are positioned at opposite ends of the rod body, a substantially middle portion of the support arm is substantially perpendicularly fixed to the rod body.

15. The hanging module of claim 11, wherein the support arm comprises a main body and two mounting portions extending from the main body, each of the grooves is defined on the corresponding mounting portion, the plurality of fasteners fix each of the locking members to the corresponding mounting portion.

16. The hanging module of claim 15, wherein the mounting portions are parallel to the rod body, and are perpendicular to the main body.

17. The hanging module of claim 15, wherein each of the two mounting portions defines a pair of mounting holes, each of the locking members defines a pair of through holes corresponding to the pair of mounting holes, two of the plurality of fasteners are inserted into the pair of mounting holes and the pair of through holes, and locks the mounting portion and the corresponding locking member.

18. The hanging module of claim 17, wherein each of the grooves is located between the corresponding pair of mounting holes.

19. The hanging module of claim 14, wherein the latching unit further comprises two positioning members and four holding members, the two positioning members are fixed to the support arm, and parallel to the fixing rod, the two positioning members are located at opposite sides of the fixing rod, the holding members are mounted on opposite ends of the positioning members.

20. The hanging module of claim 19, wherein each of the holding member comprises a base portion, and two hook portions substantially perpendicularly extending from opposite ends of the base portion, the base portion is substantially perpendicularly mounted to the positioning member.
